(19) United States
(12) Patent Application Publication
(10) Pub. No.: US 2009/0017868 A1
(43) Pub. Date: Jan. 15, 2009

(54) Point-to-Point Wireless Audio Transmission

(76) Inventors: Joji Ueda, Cambridge, MA (US); Ronald N. Isaac, Shrewsbury, MA (US)

Correspondence Address: Bose Corporation;c/o Donna Griffiths, The Mountain, MS 40, IP Legal - Patent Support, Framingham, MA, 01701, US

(21) Appl. No.: 11/777,640

(22) Filed: Jul. 13, 2007

(51) Int. Cl. H04B 1/38

(52) U.S. Cl. 455/557

(57) ABSTRACT

An audio sharing device is capable of receiving audio through one wireless point-to-point link from a first external electronic device; and retransmitting that audio through another wireless point-to-point link to a second external electronic device, while also outputting that audio to a user of the audio sharing device through an acoustic driver. The audio sharing device may be further capable of transmitting other audio received from a microphone to one or both of the first and second external electronic devices. The audio sharing device may also be capable of initiating a simplified form of link establishment procedure with another audio sharing device.

### BACKGROUND

This description relates to sharing audio through wireless devices.

It has become commonplace to use devices employing point-to-point wireless communication technologies to create a personal area network in the vicinity of a user of personal electronic devices carried about by the user (referred to by some as a “piconet”) to convey audio from one of those personal electronic devices to one or both ears of the user, as in the case of the playback of audio stored on an audio playing device to the user. It has also become commonplace to additionally convey audio from the user to one of those personal electronic devices, as in the case of cell phone in which the user engages in telephonic communication through such point-to-point wireless communications with that device. Among the forms of such point-to-point wireless communications being used for such purposes are those that conform to the widely used “Bluetooth” specification promulgated by the Bluetooth Special Interest Group of Bellevue, Wash.

Wireless communications conforming to the Bluetooth specification have been in use for some time to wirelessly convey two-way audio between cell phones and so-called “earpieces” that incorporate both an acoustic driver to output audio to an ear of a user and a microphone to receive audio from the mouth of the user. More recently, there has been a growing emergence of audio playing devices employing wireless communications conforming to the Bluetooth specification to wirelessly convey one-way audio from those devices to one or more acoustic drivers to output audio to one or both ears of a user.

Unfortunately, despite the growing acceptance of such point-to-point wireless communications for the conveying of audio between personal electronic devices, the point-to-point nature, the procedures required to securely establish wireless connections, and the conversions of audio between various analog and digital forms have presented various difficulties. Those difficulties include various impediments to providing audio to both ears of a user, allowing a user to easily transition from one choice of acoustic driver and/or microphone to another, and sharing audio with a personal electronic device carried by another user.

### SUMMARY

In one aspect, the invention features an apparatus that includes a processor; a transceiver accessible to the processor and configured to send and receive wireless communications in a wireless network; and a storage accessible to the processor and having a routine stored therein comprising a sequence of instructions. When the sequence of instructions is executed by the processor, the processor is caused to operate the transceiver to receive a first piece of audio from a first external electronic device, operate the transceiver to retransmit at least a portion of the first piece of audio to a second external electronic device, and provide at least a portion of the first piece of audio to a digital-to-analog converter to create an analog audio signal to drive an acoustic driver.

Implementations of the invention may include one or more of the following features. The transceiver could be configured to transmit and/or receive signals in a manner conforming to the Bluetooth specification. The transceiver could be configured to receive audio having multiple audio channels, and the acoustic driver may be driven with one audio channel while another audio channel is retransmitted to the second external electronic device. The acoustic driver may be driven with audio on which a delay is imposed to synchronize the output of that audio with audio output by a different acoustic driver that is driven by the second external electronic device. The digital-to-analog converter, the acoustic driver, an analog-to-digital converter and a microphone may each be incorporated within the apparatus or may be external to the apparatus. The apparatus may incorporate one or both of a manually-operable control and an indicator. The control may be manually operable to remotely-control the first external electronic device and/or to initiate some form of link establishment procedure. The indicator may display information related to the first piece of audio and received from the first-external electronic device.

In on aspect, the invention features a machine-readable medium storing a sequence of instructions that when executed by a processor of an audio sharing device cause the processor to operate a transceiver configured to send and receive wireless communications in a wireless network to receive a first piece of audio from a first external electronic device; operate the transceiver to retransmit at least a portion of the first piece of audio to a second external electronic device; and provide at least a portion of the first piece of audio to a digital-to-analog converter to create an analog audio signal to drive an acoustic driver.

Implementations of the invention may include one or more of the following features. The processor may be caused to drive an acoustic driver with one audio channel and to retransmit another audio channel to the second external electronic device. The processor may be caused to impose a delay on the driving of the one audio channel to synchronize the output of the one audio channel with the output of the other audio channel through a different acoustic driver driven by the second external electronic device. The processor may be caused to receive a second piece of audio from a microphone and to transmit the second piece of audio to at least one of the first and second external electronic devices. The processor may be caused to monitor a control for an indication of being manually operated, and then to initiate a link establishment procedure with the second external electronic device. The processor may be caused to respond to an indication from the second external electronic device that the second external electronic device is an audio sharing device by altering the link establishment procedure to a simplified form of link establishment procedure. The processor may be caused to receive a piece of information from the first external electronic device regarding the first piece of audio, and then to operate an indicator to provide the piece of information to a person.

In one aspect, the invention features a portable audio sharing device that includes a processor; a transceiver accessible to the processor and configured to send and receive wireless communications in a wireless network; a digital-to-analog converter; an acoustic driver to provide audio to an ear of the person; and a storage accessible to the processor and having a routine stored therein comprising a sequence of instructions. When the sequence of instructions is executed by the processor, the processor is caused to operate the transceiver to receive a first piece of audio from a first external electronic device; operate the transceiver to retransmit at least a portion of the first piece of audio to a second external electronic device; and provide at least a portion of the first piece of audio to the digital-to-analog converter to create an analog audio signal to drive the acoustic driver.

Implementations of the invention may include one or more of the following features. The transceiver could be configured to transmit and/or receive signals in a manner conforming to the Bluetooth specification. The transceiver could be configured to receive audio having multiple audio channels, and the acoustic driver may be driven with one audio channel while another audio channel is retransmitted to the second external electronic device. The acoustic driver may be driven with audio on which a delay is imposed to synchronize the output of that audio with audio output by a different acoustic driver that is driven by the second external electronic device. The apparatus may incorporate one or both of a manually-operable control and an indicator. The control may be manually operable to remotely control the first external electronic device and/or to initiate some form of link establishment procedure. The processor may be caused to monitor the control for an indication of being manually operated, and then to initiate a link establishment procedure with the second external electronic device. The processor may be caused to respond to an indication from the second external electronic device that the second external electronic device is an audio sharing device by altering the link establishment procedure to a simplified form of link establishment procedure. The indicator may display information related to the first piece of audio and received from the first external electronic device. The processor may be caused to receive a piece of information from the first electronic device regarding the first piece of audio, and then to create additional audio representing the piece of information and mixing the additional audio with audio driven to the acoustic driver.

### DESCRIPTION OF DRAWINGS

FIG 1 is a block diagram of a wireless network incorporating multiple audio sharing devices and a personal electronic device.

FIG. 2 is a block diagram of an audio sharing device of FIG. 1.

FIG. 3 is another block diagram of a wireless network incorporating multiple audio sharing devices and a personal electronic device.

FIG. 4 is a block diagram of an audio sharing device of FIG. 3.

FIG. 5 is still another block diagram of a wireless network incorporating multiple audio sharing devices and a personal electronic device.

FIG. 6 is yet another block diagram of a wireless network incorporating multiple audio sharing devices and a personal electronic device.

### DESCRIPTION

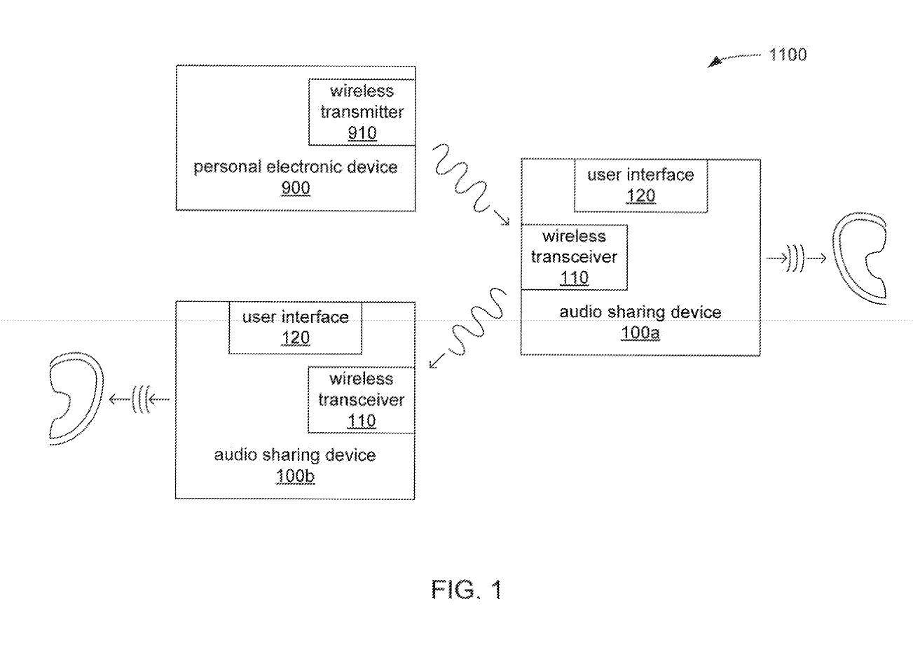

FIG. 1 depicts a network 1100 enabling the transfer of audio between, three personal electronic devices, specifically, a personal electronic device 900 and multiple audio sharing devices 100a and 100b. As depicted, the network 1100 (or at least the depicted portion of it) is of a daisy-chained point-to-point topography in which the personal electronic device 900 transmits audio to the audio sharing device 100a via one point-to-point link, and in turn, the audio sharing device 100a retransmits the audio to the audio sharing device 100b via another point-to-point link. It should be noted that although only the audio sharing devices 100a and 100b are depicted, those skilled in the art will readily recognize that other embodiments of the network 1100 may have longer chains of more than two audio sharing devices employing a chain of point-to-point links. The technology on which the network 1100 is based may be of any of a wide variety of types employing RF signals, infrared signals, or any of a variety of other forms of wireless transmission media. Where the network 1100 employs RF signals, at least a portion of the network 1100 may at least partially conform to the Bluetooth specification, or to any of a variety of other specifications for wireless networking as would be appropriate in shortness of range and limitation, of power consumption for use between personal electronic devices carried by a user.

Where at least a portion of the network 1100 at least partially conforms to the Bluetooth specification,, one or more of the “profiles” in the Bluetooth specification for the transfer of audio may be used (either one-way or two-way, and either monaural or with multiple audio channels), and/or one or both of the audio sharing devices 100a and 100b may participate in some form of link establishment procedure to set up point-to-point links between devices. As those familiar with the Bluetooth specification and similar point-to-point networks will readily recognize, such a link establishment procedure must be performed to cause devices to recognize each other and to accept communications between them, as well as to establish encryption keys or other security measures between them. Furthermore, those familiar with the Bluetooth specification and similar point-to-point networks will readily recognize that during such a link establishment procedure between two devices, information is exchanged between them by which each device provides various indications as to functions it performs and/or parameters for the types of data that it could exchange across a point-to-point linkage that could be established between them. More specifically regarding the Bluetooth specification, a device capable of supporting one or more profiles that entail the exchange of audio data and/or commands must indicate which of such profiles it supports. Among the Bluetooth profiles that may be supported by one or both of the audio sharing devices 100a and 100b for conveying at least one-way audio and/or commands are the general audio/video distribution profile (GAVDP), the advanced audio distribution profile (A2DP), the human interface device protocol (HIDP), the audio/video remote control profile (AVRCP), and the serial port profile (SPP).

The audio sharing devices 100a and 100b are, themselves, personal electronic devices, at least one of which may be employed by the user of the personal electronic device 900 to convey audio transmitted by the personal electronic device 900 to an acoustic driver (not shown) to allow the user to hear it. As depicted in FIG. 1, and as will be discussed in greater detail, each of the audio sharing devices 100a and 100b incorporate a wireless transceiver 110 enabling the reception and retransmission of audio from the personal electronic device 900. In some embodiments, the wireless transceiver 110 is capable of RF point-to-point communications conforming to the Bluetooth specification, and audio is received from the personal electronic device 900 and/or retransmitted between the audio sharing devices 100a and 100b via one or more forms of one-way stereo audio data streaming supported by the Bluetooth specification (e.g., GAVDP or A2DP). Further, each of the audio sharing devices 100a and 100b incorporates a user interface 120 by which, the operation of one or more of the audio sharing devices 100a and 100b, and the personal electronic device 900 may be monitored and/or controlled. In some embodiments, the user interface 120 incorporates one or more manually operable controls by which a user may cause a command to be transmitted either between the audio sharing devices 100a and 100b, or to the personal electronic device 900. Where point-to-point communications conforming to the Bluetooth specification are employed, the transmission of such commands may be via HIDP or AVRCP, or still other Bluetooth profiles.

The personal electronic device 900 may be any of a variety of types of personal electronic device, including but not limited to, various multimedia, information handling and/or communications devices such as a cell phone, a digital music player (e.g., a typical MP3 music file player), portable camera with playback function, a personal data assistant (PDA), or a personal navigation device. The personal electronic device 900 incorporates a wireless transmitter 910 by which the personal electronic device 900 transmits audio to the audio sharing device 100a. However, as those skilled in the art will readily recognize, depending on what functions the personal, electronic device 900 is capable of performing, a wireless transceiver capable of both transmission (including transmission of audio to the audio sharing device 100a) and reception may be substituted, for the wireless transmitter 910. Indeed, depending on whether the Bluetooth specification or other similar form of communication is employed by the personal electronic device 900, the use of a wireless transceiver (instead of the wireless transmitter 910) may be required to support a link establishment procedure and/or to perform other functions that enable a point-to-point link between the personal electronic device 900 and the audio sharing device 100a to be set up and/or utilized. Where such a wireless transceiver is substituted for the wireless transmitter 910, the personal electronic device 900 may accept commands related to the transmission of audio from one or both of the audio sharing devices 100a and 100b.

Where two different users of personal electronic devices wish to both receive audio transmitted by the personal electronic device 900, and where point-to-point links conforming to the Bluetooth specification or a similar networking specification are employed, a link establishment procedure is first carried out to form the point-to-point links. A link establishment procedure is performed to set up the point-to-point link between the personal electronic device 900 and the audio sharing device 100a. Manually-operable controls provided by the user interface 120 and corresponding controls of the personal electronic device 900 may be employed to cause this link establishment procedure between the audio sharing device 100a and the personal electronic device 900 to occur. During this link establishment procedure, the personal electronic device 900 and the audio sharing device 100a provide indications to each other of functions that each performs and/or types of data exchange that each supports. It may be found that the exchange of one or more of one-way stereo audio, two-way conversational audio and commands may be found to be supported by both, and would thereby be enabled for use. Also, a similar link establishment procedure is performed to set up the point-to-point link between the audio sharing devices 100a and 100b.

Following such link establishment procedures, the personal electronic device 900 transmits audio to the audio sharing device 100a via the point-to-point, link set up between them. The audio sharing device 100a receives this audio and retransmits this audio to the audio sharing device 100b. In this way, a user of the audio sharing device 100a and a user of the audio sharing device 100b may both hear the same audio being transmitted by the personal electronic device 900. In some embodiments, indicators provided by the user interface 120 may allow indications of information related to the audio to be presented to one or both of these users, including but not limited to, a visual indication of elapsed time of playback of a specific audio recording and/or textual data conveying its author and title. Also, in some embodiments, manually-operable controls provided by the user interface 120 may make possible the remote operation of the personal electronic device 900 to control aspects of the transmission of the audio, including but not limited to, the ability to cause an audio recording to be played, fast-forwarded or paused.

It is envisioned as one possibility that the user of the personal electronic device 900 and the audio sharing device 100a may be one and the same person, and that this one user normally employs the audio sharing device 100a in his/her own use of the personal electronic device 900, while perhaps momentarily allowing the user of the audio sharing device 100b to share in listening to audio transmitted by the personal electronic device 900. To do this, this one user and the user of the personal sharing device 100b might then both operate their respective, audio sharing devices 100a and 100b to initiate a link establishment, procedure to form a link between the audio sharing devices 100a and 100b, and thereby enable the retransmission of the audio to the audio sharing device 100b. However, it should be noted, and as will be made more clear, other forms and uses of audio sharing devices are possible in which the users of a personal electronic device and an audio sharing device between which a point-to-point link is formed need not be one and the same person.

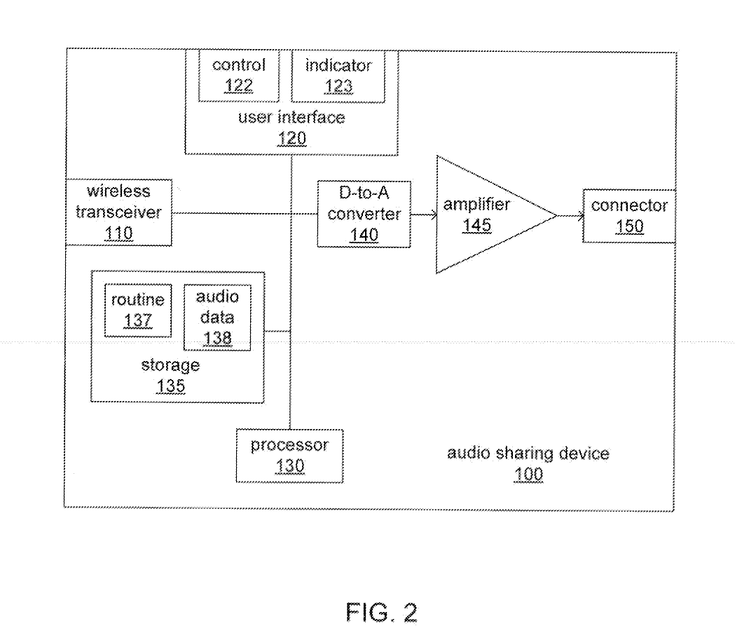

FIG. 2 is a block diagram of an audio sharing device 100 such as may be employed as embodiments of one or both of the audio sharing devices 100a and 100b of the network 1100 of FIG. 1. The audio sharing device 100 enables the reception and retransmission of audio to another audio sharing device (not shown) to thereby allow two users to hear the same audio. The audio sharing device 100 incorporates a wireless transceiver 110, a user interface 120, a processor 130 and a storage 135. Also, depending on the manner in which the audio sharing device 100 participates in providing audio to at least one ear of a user, the audio sharing device 100 may incorporate one or more of a digital-to-analog converter (D-to-A converter) 140, an amplifier 145 and a connector 150.

Not unlike the wireless transceiver 110 of the audio sharing devices 100a and 100b of FIG. 1, the wireless transceiver 110 of the audio sharing device 100 is able to receive audio through one point-to-point link, and retransmit that audio to another audio sharing device (or still other forms of personal electronic device) through another point-to-point link. Where such point-to-point links conform to the Bluetooth specification or a similar specification for point-to-point wireless communication, the wireless transceiver 110 may be used in carrying out the sending and receiving of indications of supported functionality and/or exchangeable types of data during a link establishment procedure employed in setting up a point-to-point link.

The user interlace 120 incorporates one or both of a control 122 and an indicator 123. The control 122 may be any type of manually-operable control, including but not limited to, a button, a lever switch, a rotatable knob, a touch-screen sensor, a pressure sensor, a proximity sensor or an orientation sensor. The indicator 123 may be any of a number of possible devices conveying information to a user of the audio sharing device 100, including but not limited to, a graphical display capable of depleting various symbols and/or language characters, one or more LEDs, a buzzer, or a vibration-generating device. Alternatively, information may be provided to a user of the audio sharing device 100 through the output of audio conveying that information which is mixed with the audio received by the wireless transceiver 110, with the mixed audio being output to the user. Where the control 122 is provided, the control 122 may be employed for one or both of performing some form of link establishment procedure and controlling one or more aspects of the provision of audio to a user (e.g., the volume employed in outputting audio to the user).

In embodiments where the audio sharing device 100 drives a separate acoustic driver (not shown), the audio sharing device 100 may incorporate the connector 150 by which the audio sharing device is able to be connected to an external acoustic driver, such as a speaker, a pair of headphones, etc. In embodiments where the audio sharing device 100 incorporates an acoustic driver within a casing of the audio sharing device 100 (such as where the audio sharing device 100 is, itself, a speaker, a pair of headphones, etc.), the connector 150 may not be present. In either of such embodiments, the audio sharing device 100 may incorporate one or both of the D-to-A converter 140 and the amplifier 145 to drive an acoustic driver (whether external or incorporated within) with the audio received through the wireless transceiver 110. Alternatively, where the connector 150 is provided to connect the audio sharing device with an external acoustic driver, the connector 150 may convey through the connector 150 a digital signal representing the audio that was received through the wireless transceiver in support of an external acoustic driver having its own D-to-A converter and/or amplifier. Doing so may obviate the need for the audio sharing device 100 to incorporate either of the D-to-A converter 140 or the amplifier 145 in some embodiments. An example implementation of this may be where the connector 150 conforms to the Universal Serial Bus specification (USB specification) promulgated by the USB Implemented Forum, Inc. of Beaverton, Oreg., and is employed in conveying such a digital signal to an acoustic driver having an interface that also conforms to the USB specification.

The processor 130 may be any of a variety of types of processing device, including but not limited to, a general purpose processor, a digital signal processor or other more specialized processor having a limited instruction set optimized for a given range of functions, a microcontroller or combinational logic. The storage 135 may be based on any of a wide variety of information storage technologies, including but not limited to, static RAM, dynamic RAM, ROM of either erasable or non-erasable form, FLASH, magnetic memory, ferromagnetic disk storage, phase-change storage or magneto-optical storage. The storage 135 carries one or both of a routine 137 and audio data 138. The processor 130 executes at least one sequence of instructions of the routine 137 and is thereby caused to carry out one or both of a link establishment procedure and the retransmission of audio. During the retransmission of audio, the processor 130 may be caused by the routine 137 to store portions of the audio received through the wireless transceiver 110 as at least a portion of the audio data 138 in the storage 135 in preparation for retransmission by the wireless transceiver 110 and/or output to a user.

In embodiments in which the processor 130 carries out some form of link establishment procedure to enable a point-to-point link between the audio sharing device 100 and another device, the processor 130 is caused by the routine 137 to monitor the user interface 120 for an indication that the control 122 has been operated by a user to initiate a link establishment procedure. Upon receiving such an indication, the processor 130 operates the wireless transceiver 110 to receive indications of the functionality and/or exchangeable data types supported by the other device with which a link is to be set up, and the processor 130 operates the wireless transceiver 110 to transmit similar indications to the other device. When the link establishment procedure has been concluded such that a point-to-point link has been set up between the audio sharing device 100 and the other device, the processor 130 may be caused to operate the indicator 123 of the user interface 120 to provide an indication of the results of the link establishment procedure to the user.

In some embodiments where the processor 130 carries out such a link establishment procedure, the processor 130 may be caused by the routine 137 to carry out a simplified, variant of the link establishment procedure where a user seeks to form a point-to-point link between the audio sharing device 100 and another incarnation of the audio sharing device 100 or similar audio sharing device. The processor 130 may respond to detecting that the other device is another audio sharing device by signaling the other device with an indication that the audio sharing device 100 is also an audio sharing device, and the two devices may engage in a simplified form of link establishment procedure to avoid unnecessarily inconveniencing the users of both devices with the greater complexity and time involved in a more conventional link establishment procedure.

In embodiments in which the processor 130 carries out the retransmission of audio received through the wireless transceiver 110, the processor 130 is caused by the routine 137 to operate the wireless transceiver 110 to receive the audio and to temporarily store portions of the received audio as at least a portion the audio data 138 in the storage 135. This buffering of the received audio as at least a portion of the audio data 138 may be required by one or both of the retransmission of the audio to another device and the provision of the audio to the user of the audio sharing device 100. The processor 130 is also caused to operate the wireless transceiver 110 to perform the retransmission of the received audio, and the processor 130 is further caused to provide the audio to the wireless transceiver 110 at a rate appropriate for the retransmission. As the retransmission occurs, the processor 130 may also be caused to operate the D-to-A converter 140 and the amplifier 145 to convert the audio from a digital form to an analog form of sufficient amplitude to drive to an acoustic driver, and the processor 130 is further caused to provide the audio to the D-to-A converter 140 at a rate appropriate for the conversion to analog form. Alternatively, as the retransmission occurs in an embodiment of the audio sharing device in which the connector 150 is employed in outputting the received audio as a stream of digital data, the processor 130 may also be caused to output the audio through the connector 150 at a rate appropriate to match chosen bit and sampling rates.

In some embodiments where audio is stored as the audio data 138, the processor 130 may be further caused by the routine 137 to perform some degree of signal processing and/or time-delay function on at least a portion of the audio data 138. For example, where the audio sharing device 100 incorporates an acoustic driver, signal processing may be performed to compensate for characteristics of that acoustic driver (e.g., bass and/or treble adjustments, amplitude expansion or compression, re-equalization, low-pass or high-pass filtering, resynchronization to a different sampling rate, etc.). Also, there may be a need to impose a time-delay in the output of audio by an acoustic driver connected to either the audio sharing device 100 or to the other device to which the audio sharing device 100 retransmits audio in order to synchronize the output of audio by acoustic drivers attached to both devices. To enable this synchronization, the sharing device 100 may create and incorporate a synchronization signal in the retransmitted audio for use by the other device in synchronizing the output of audio by acoustic drivers attached to both devices (in some embodiments, the processor 130 may be caused to do this). For example, a single user may be listening to left and right channels through different acoustic drivers that are each attached to one or the other of the audio sharing device 100 and another device to which the audio sharing device 100 retransmits audio, and the audio output by one or the other of these devices to the user may need to be delayed to ensure that the left and right channels are synchronized.

The audio sharing device 100 may be employed to perform a wide variety of functions. Although much of the above discussion has focused on the use of multiple incarnations of the audio sharing device 100 to allow multiple persons to sharing in listening to a single transmission of audio from a personal electronic device, multiple incarnations of the audio sharing device 100 may be employed by one person. One person may wish to use multiple incarnations of the audio sharing device 200 to provide the audio received from a personal electronic device to both ears, to provide the audio to multiple locations in a given space, and/or to provide a spatially separated output of different channels of the same audio (e.g., the left and right channels of stereo audio) through separate acoustic drivers for each channel.

The audio sharing device 100 may take any of a wide range of possible physical forms. In some embodiments, the audio sharing device 100 may be a pair of headphones such that the audio sharing device incorporates at least two acoustic drivers (one for each ear of a user), and therefore, may not incorporate the connector 150. In other embodiments, the audio sharing device 100 may be a device not incorporating an acoustic driver, and having a casing designed to be of desirable size and shape for being worn or carried by a user in various ways intended to make the attachment of a pair of headphones, one or more in-ear acoustic drivers, or other form of acoustic driver worn or carried by the user relatively conveniently.

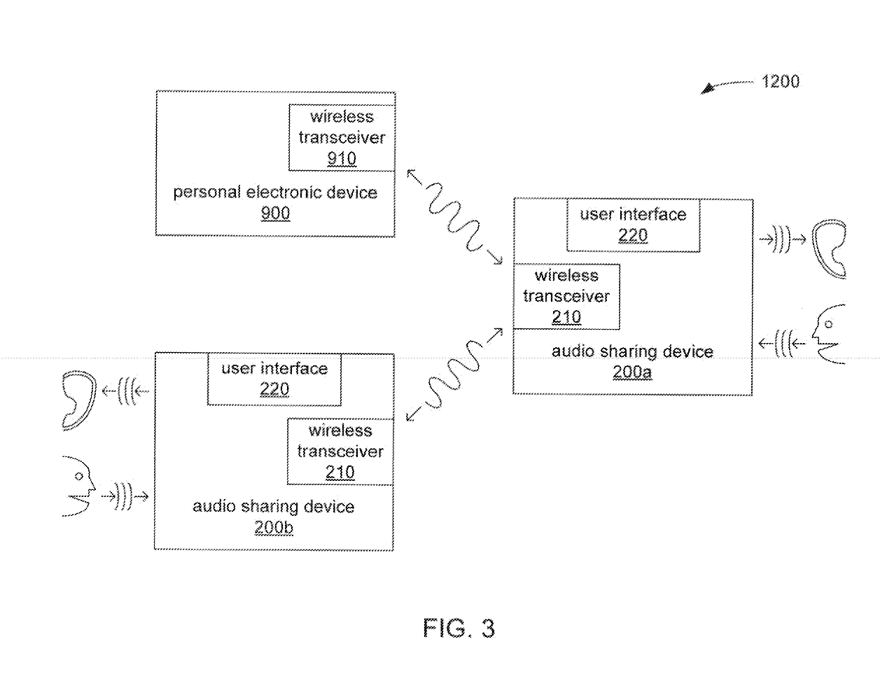

FIG. 3 depicts a network 1200 enabling the transfer of audio between three personal electronic devices, specifically, a personal electronic device 900 and multiple audio sharing devices 200a and 200b. The network 1200 (or at least the depleted portion of it) is of a daisy-chained point-to-point topography in which the personal electronic device 900 exchanges audio with the audio sharing device 200a via one point-to-point link, and in turn, the audio sharing device 200a exchanges audio with the audio sharing device 200b via another point-to-point link. It should be noted that although only the audio sharing devices 200a and 200b are depicted, those skilled in the art will readily recognize that other embodiments of the network 1200 may have longer chains of more than two audio sharing devices employing a chain of point-to-point links. Not unlike the network 1100 of FIG. 1, the technology on which the network 1200 is based may be of any of a wide variety of types, and in embodiments where the network 1200 employs RF signals, at least a portion of the network 1200 may at least partially conform to the Bluetooth specification, or to any of a variety of other specifications for wireless networking.

Where at least a portion of the network 1200 at least partially conforms to the Bluetooth specification, profiles in the Bluetooth specification allowing for one or both of one-way stereo audio and two-way monaural audio may be used, and/or one or both of the audio sharing devices 200a and 200b may participate in link establishment procedures to set up point-to-point links between devices. As will be discussed in greater detail, the audio sharing devices 200a and 200b support two-way exchanges of audio, which is a substantial difference from the audio sharing devices 100a and 100b of FIG. 1, and the audio sharing device 100 of FIG. 2. As a result, the audio sharing devices 200a and 200b are capable of supporting both the Bluetooth profiles previously discussed with reference to those previously-discussed audio sharing devices, and additional Bluetooth profiles supporting two-way exchanges of audio. Among these additional Bluetooth profiles that may be supported by one or both of the audio sharing devices 200a and 200b are the headset profile (HSP), the hands-free profile (HFP), the intercom profile (ICP) and the cordless telephony profile (CTP).

The audio sharing devices 200a and 200b are, themselves, personal electronic devices, at least one of which may be employed by the user of the personal electronic device 900 to convey audio transmitted by the personal electronic device 900 to an acoustic driver (not shown) to allow the user to hear it, and to convey audio detected by a microphone (not shown) back to the personal electronic device. As depicted in FIG. 3, and as will be discussed in greater detail, each of the audio sharing devices 200a and 200b incorporate a wireless transceiver 210 enabling the reception and retransmission of audio from the personal electronic device 900, and enabling the transmission or retransmission of audio to the personal electronic device 900. In some embodiments, the wireless transceiver 210 is capable of RF point-to-point communications conforming to the Bluetooth specification, and audio is exchanged with the personal electronic device 900 and/or retransmitted between the audio sharing devices 200a and 200b via one or more forms of two-way audio data streaming supported by the Bluetooth specification (e.g., HSP or HFP). Further, each of the audio sharing devices 200a and 200b incorporates a user interface 220 by which the operation of one or more of the audio sharing devices 200a and 200b, and the personal electronic device 900 may be monitored and/or controlled. In some embodiments, the user interface 220 incorporates one or more manually operable controls by which a user may cause a command to be transmitted either between the audio sharing devices 200a and 200b, or to the personal electronic device 900. Where point-to-point communications conforming to the Bluetooth specification are employed, the transmission of such commands may be via HFP or still other Bluetooth profiles.

The personal electronic device 900 may be any of a variety of types of personal electronic device capable of two-way exchanges of audio, including but not limited to, a cell phone. The personal electronic device 900 incorporates a wireless transceiver 910 by which the personal electronic device 900 exchanges audio with the audio sharing device 200a, and/or by which the personal electronic device 900 may perform some form of link establishment procedure to set up a link with the audio sharing device 200a.

Where two different users of personal electronic devices wish to exchange audio among the personal electronic device 900 and both of the audio sharing devices 200a and 200b, and where point-to-point links conforming to the Bluetooth specification or a similar networking specification are employed, a link establishment procedure is first carried out to form the point-to-point links. Not unlike the network 1100 of FIG. 1, in the network 1200, a link establishment procedure is performed to set up the point-to-point link between the personal electronic device 900 and the audio sharing device 200a. Manually-operable controls provided by the user interface 220 and corresponding controls of the personal electronic device 900 may be employed to cause this link establishment procedure between the audio sharing device 200a and the personal electronic device 900 to occur. During this link establishment procedure, the personal electronic device 900 and the audio sharing device 200a provide indications to each other of functions that each performs and/or types of data exchange that each supports. It may be found that the exchange of one or more of one-way stereo audio, two-way conversational audio and commands may be found to be supported by both, and would thereby be enabled for use. Also not unlike the network 1100 of FIG. 1, a similar link establishment procedure is performed to set up the point-to-point link between the audio sharing devices 200a and 200b.

Following such link establishment procedures, the personal electronic device 900 is able to exchange audio with the audio sharing device 200a via the point-to-point link set up between them, and the audio sharing device 200a exchanges audio with the audio sharing device 200b. Also, as these two exchanges of audio occur, the audio sharing device 200a is able to retransmit audio that it receives from the personal electronic device 900 to the audio sharing device 200b, and is similarly able to retransmit audio that it receives from the audio sharing device 200b to the personal electronic device 900. In this way, a user of the audio sharing device 200a and a user of the audio sharing device 200b may both hear the same audio being transmitted by the personal electronic device 900, and may both transmit audio back to the personal electronic device 900, as well as exchange audio between each other through the audio sharing devices 200a and 200b. In some embodiments, indicators provided by the user interface 220 may allow indications of information related to at least some of the audio being exchanged to be presented to one or both, of these users, including but not limited to, a visual indication of a phone number with which these users are in communication through the personal electronic device 900. Also, in some embodiments, manually-operable controls provided by the user interlace 220 may make possible the remote operation of the personal electronic device 900 to control aspects of the exchange of audio, including but not limited to, the ability to remotely initiate or end a phone call.

It is envisioned as one possibility that the user of the personal electronic device 900 and the audio sharing device 200a may be one and the same person, and that this one user normally employs the audio sharing device 200a in his/her own use of the personal electronic device 900, while perhaps momentarily allowing the user of the audio sharing device 200b to share in conversation that entails the exchange of audio between the personal electronic device 900 and the audio sharing device 200a. To do this, this one user and the user of the personal sharing device 200b might then both operate their respective audio sharing devices 200a and 200b to initiate a link establishment procedure to form a link between the audio sharing devices 200a and 200b, and thereby enable the audio sharing device 200b to exchange audio with the audio sharing device 200a and the personal electronic device 900 (through the audio sharing device 200a). However, it should be noted, and as will be made more clear, other forms and uses of audio sharing devices are possible in which the users of a personal electronic device and an audio sharing device between which a point-to-point link is formed need not be one and the same person.

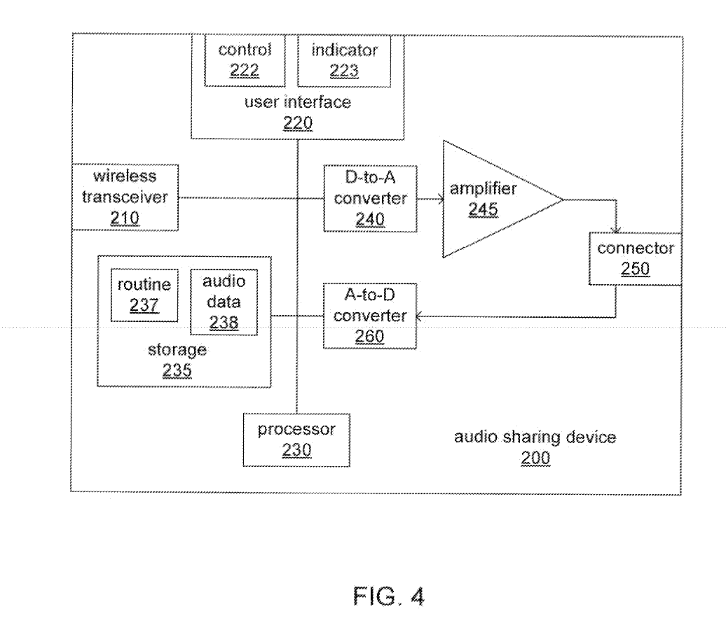

FIG. 4 is a block diagram of an audio sharing device 200 such as may be employed as an embodiment of one or both of the audio sharing devices 200a and 200b of the network 1200 of FIG. 3. The audio sharing device 200 enables the reception and retransmission of audio between two other devices (not shown) to thereby allow multiple users to both transmit and receive audio between them. The audio sharing device 200 incorporates a wireless transceiver 210, a user interface 220, a processor 230 and a storage 235. Also, depending on the manner in which the audio sharing device 200 participates in providing audio to at least one ear of a user and allows that user to provide speech in return, the audio sharing device 200 may incorporate one or more of a D-to-A converter 240, an amplifier 245, a connector 250, and an analog-to-digital converter (A-to-D converter) 260.

Not unlike the wireless transceiver 210 of the audio sharing devices 200a and 200b of FIG. 3, the wireless transceiver 210 of the audio sharing device 200 is able to receive audio through one point-to-point link, and retransmit that audio through another point-to-point link, and vice versa. Where such point-to-point links conform to the Bluetooth specification or a similar specification for point-to-point wireless communication, the wireless transceiver 210 may be used in carrying out the sending and receiving of indications of supported functionality and/or exchangeable types of data during a link establishment procedure employed in setting up a point-to-point link.

Not unlike the user interface 120 of the audio sharing device 100 of FIG. 2, the user interface 220 incorporates one or both of a control 222 and an indicator 223. The control 222 may be any type of manually-operable control, and the indicator 223 may be any of a number of possible devices conveying information to a user of the audio sharing device 200. Alternatively, information may be provided to a user of the audio sharing device 200 through mixing audio conveying that information with audio, received by the wireless transceiver 210, and outputting the mixed audio to the user. Where the control 222 is provided, the control 222 may be employed for one or both of performing some form of link establishment procedure and controlling one or more aspects of the provision of audio to a user (e.g., the volume employed in outputting audio to the user, or remotely controlling a function of another personal electronic device).

In embodiments where the audio sharing device 200 drives a separate acoustic driver (not shown), and receives audio spoken by a user through a separate microphone (also not shown), the audio sharing device 200 may incorporate the connector 250 by which the audio sharing device is able to be connected to that external acoustic driver and/or that microphone. In embodiments where the audio sharing device 200 incorporates an acoustic driver and/or a microphone within a casing of the audio sharing device 200 (such as where the audio sharing device 200 is, itself, a handset, a speakerphone, a headset, etc.), the connector 250 may not be present, in either of such embodiments, the audio sharing device 200 may incorporate one or both of the D-to-A converter 240 and the amplifier 245 to drive an acoustic driver (whether external or incorporated within), and the audio sharing device 200 may incorporate the A-to-D converter to convert audio received from a microphone (whether external or incorporated within) to digital form for transmission. Alternatively, where the connector 250 is provided to connect the audio sharing device with an external acoustic driver and/or an external microphone, the connector 250 may convey audio in digital form to an external acoustic driver having its own D-to-A converter or from an external microphone having its own A-to-D converter.

Not unlike the processor 130 and the storage 135 of the audio sharing device 100, the processor 230 may be any of a variety of types of processing device and the storage 235 may be based on any of a wide variety of information storage technologies. The storage 235 carries one or both of a routine 237 and audio data 238. The processor 230 executes at least one sequence of instructions of the routine 237 and is thereby caused to carry out one or more of a link establishment procedure, the retransmission of audio received from other devices, and the exchange of audio with a user of the audio sharing device 200 through an acoustic driver and a microphone. During the retransmission of audio, the processor 230 may be caused by the routine 237 to store portions of the audio received through the wireless transceiver 210 as at least a portion of the audio data 238 in the storage 235 in preparation for retransmission by the wireless transceiver 210 and/or output to a user. Also, the processor 230 may be caused by the routine 237 to store portions of audio received from a microphone, either incorporated within the audio sharing device 200 or external to it, as at least a portion of the audio data 238 in the storage 235 in preparation for transmission by the wireless transceiver to one or more other personal electronic devices.

In embodiments in which the processor 230 carries out some form of link establishment procedure to enable a point-to-point link between the audio sharing device 200 and another device, the processor 230 is caused by the routine 237 to monitor the user interface 220 for an indication that the control 222 has been operated to initiate a link establishment procedure, and then to perform-the link establishment procedure. When the link establishment procedure has been concluded, the processor 230 may be caused to operate the indicator 223 of the user interface 220 to provide an indication of the results of the link establishment procedure to the user. Furthermore, the processor 230 may be caused by the routine 237 to carry out a simplified variant of the link establishment procedure where a user seeks to form a point-to-point link, between the audio sharing device 200 and another incarnation of the audio sharing device 200 or similar audio sharing device (perhaps an incarnation of the audio sharing device 100). The processor 230 may respond to detecting that the other device is another audio sharing device by signaling the other device with an indication that the audio sharing device 200 is also an audio sharing device, and the two devices may engage in a simplified form of link establishment procedure.

In embodiments in which the processor 230 carries out the retransmission of audio received through the wireless transceiver 210, the processor 230 is caused by the routine 237 to operate the wireless transceiver 210 to receive the audio and to temporarily store portions of the received audio as at least a portion of the audio data 238 in the storage 235. This buffering of the received audio as at least a portion of the audio data 238 may be required by one or both of the retransmission of the audio to another device and the provision of the audio to the user of the audio sharing device 200. The processor 230 is also caused to operate the wireless transceiver 210 to perform the retransmission of the received audio, and caused to provide the audio to the wireless transceiver 210. As the retransmission occurs, the processor 230 may also be caused to operate the D-to-A converter 240 and the amplifier 245 to convert the audio from a digital form to an analog form of sufficient amplitude to drive to an acoustic driver, and caused to provide the audio to the D-to-A converter 240. Alternatively, as the retransmission occurs in an embodiment of the audio sharing device in which the connector 250 is employed in outputting the received audio as a stream of digital data, the processor 230 may also be caused to output the audio through the connector 250.

In embodiments in which the processor 230 carries out the transmission of audio received from either an external microphone through the connector 250 or from a microphone incorporated internally within the audio sharing device 200, the processor 230 is caused by the routine 237 to operate the A-to-D converter to receive the audio and to temporarily store portions of the received audio as at least a portion of the audio data 238 in the storage 235. Alternatively, the processor 230 may also be caused to receive audio through the connector 250 already in a digital form. This buffering of the received audio as at least a portion of the audio data 238 may be required for the transmission of the audio to another device. The processor 230 is also caused to operate the wireless transceiver 210 to perform the transmission of the audio, and caused to provide the audio to the wireless transceiver 210.

In some embodiments where audio is stored as at least a portion of the audio data 238, the processor 230 may be further caused by the routine 237 to perform some degree of signal processing and/or time-delay function on the audio data 238. For example, where the audio sharing device 200 incorporates an acoustic driver and/or a microphone, signal processing may be performed to compensate for characteristics of that acoustic driver or that microphone (e.g., bass and/or treble adjustments, amplitude expansion or compression, re-equalization, low-pass or high-pass filtering, resynchronization to a different sampling rate, etc.). Also, there may be a need to impose a time-delay in the output of audio by an acoustic driver connected to either the audio sharing device 200 or to the another device with which the audio sharing device 200 retransmits audio in order to synchronize the output of audio by acoustic drivers attached to both devices. Similarly, there may be a need to impose a time-delay in the output of audio received from a microphone to another device.

The audio sharing device 200 may be employed to perform a wide variety of functions. The above-described capabilities of the audio sharing device 200 allows multiple incarnations of the audio sharing device 200 to be used by multiple persons to engage in two-way audio communications among themselves, and allows an exchange audio with still another personal electronic device in a manner not unlike what is depicted in FIG. 3. Where that other personal electronic device is a cell phone, walkie talkie, cordless phone base station or other communications device, the audio communications in which the users of the multiple incarnations of the audio sharing device 200 are engaged can be extended to include still another person through that personal electronic device. Where point-to-point links conforming to the Bluetooth specification or other wireless network specification are employed, more than one unrelated exchange of audio may take place through one or more of the point-to-point links, simultaneously. For example, amidst such a conversation between multiple persons using multiple incarnations of the audio sharing device 200 and another person through another form of personal electronic device, one of those participating in the conversation through one of the incarnations of the audio sharing device 200 may operate his/her audio sharing device to switch to listening to music stored on the personal electronic device, thereby causing that music to be streamed across at least one of the point-to-point links from the personal electronic device alongside the two-way exchanges of the audio of the conversation. In switching between participating in the conversation and listening to the music, in this example, this particular participant may make use of a control 222 of his/her incarnation of the audio sharing device 200 to remotely control the personal electronic device to cause it to commence playing the music, and possibly to cause it to pause, fast-forward, etc. Furthermore, this remote control capability could be used by this participant or one of the other participants employing another incarnation of the audio sharing device 200, to send a command to the personal electronic device to activate a mute feature thereby allowing the participants using audio sharing devices to talk among themselves with the participant(s) communicating through the personal electronic device not being able to hear them. Again, these are but examples of the possible functionality enabled by such embodiments of audio sharing devices and wireless networks that employ them.

The audio sharing device 200 may take any of a wide range of possible physical forms. In some embodiments, the audio sharing device 200 may be an earpiece or headset such that the audio sharing device incorporates at one acoustic driver and at least one microphone, and therefore, may not incorporate the connector 250. In other embodiments, the audio sharing device 200 may be a device not incorporating either an acoustic driver or a microphone, and having a casing designed to be of desirable size and shape for being worn or carried by a user in various ways intended to make the attachment of an earpiece, headset, or other combination of microphone and acoustic driver worn or carried by the user relatively conveniently.

As previously discussed with reference to both the audio sharing devices 100 and 200, embodiments of these audio sharing devices may be capable of performing a simplified form of link establishment procedure when the point-to-point link that is to be set up is with another incarnation of one of these audio sharing devices. In some variations of the audio sharing devices 100 and 200, provision may be made for users of these audio sharing devices to be able to manually initiate the performance of a simplified form of link establishment procedure, themselves, instead of relying on such a simplified form of link establishment procedure to take place automatically, as previously described. This would allow users of such audio sharing devices to more quickly create point-to-point links to enable the sharing of audio from an audio playing device or to enable others to join in a telephone call in a more agreeable “ad-hoc” manner that does not require waiting through a lengthier and fuller version of link establishment procedure that would necessitate delaying listening to audio playback or delaying carrying on a phone conversation for an extended period of time. For example, such audio sharing devices may enable users to do this by making provision for users to press and hold the control 122 or 222 of incarnations of the audio sharing devices 100 or 200, respectively, to initiate such a simplified link establishment procedure. It may be that such controls 122 or 222 are meant to more frequently be used in controlling aspects of the manner in which exchanges of audio are carried out, such as “play” or “call” buttons that normally remotely control another personal electronic device, but which cause a simplified link establishment procedure to be initiated when pressed and held. Further, such audio devices may similarly enable users who no longer desire to maintain a point-to-point link that has been set up through a simplified link establishment procedure to signal their own audio sharing devices (such as the audio sharing devices 100 or 200) to cease to maintain that link. Such simplified link establishment procedure functionality may be meant to conform, at least in some way, with widely used specification such as Bluetooth, or may be a proprietary procedure carried out between audio sharing devices of only one vendor or a limited number of vendors.

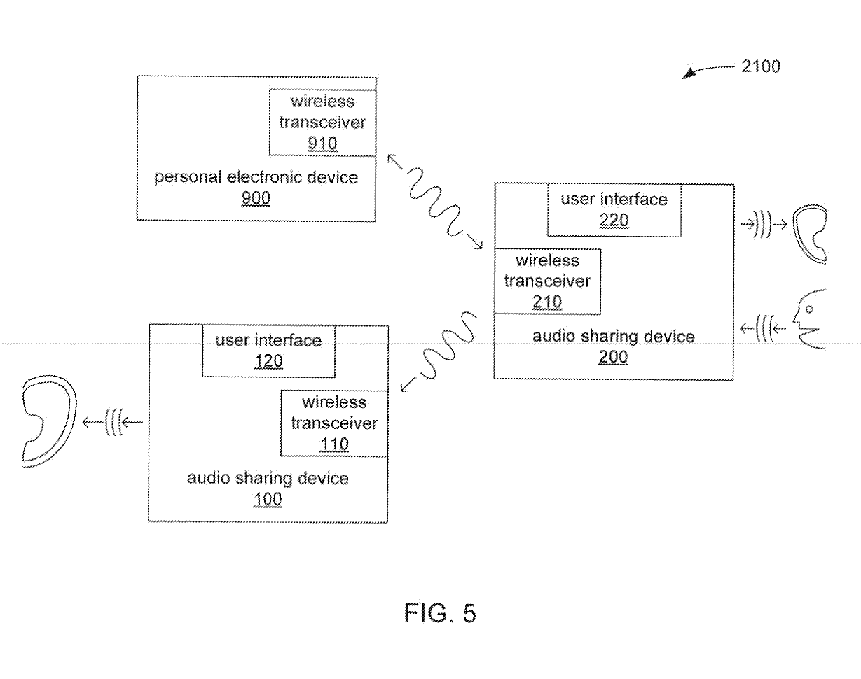

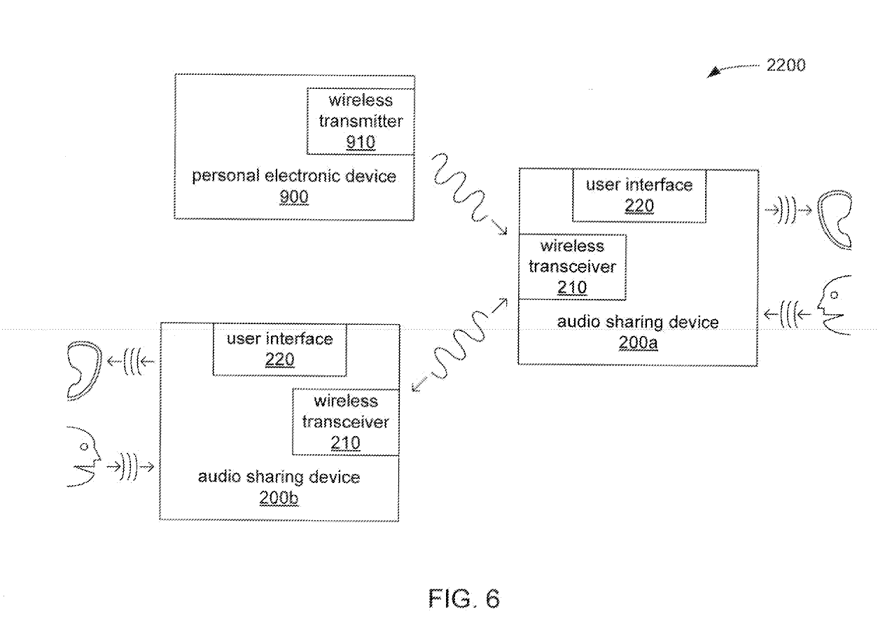

FIGS. 5 and 6 depict still other a networks 2100 and 2200, respectively, in which other possible combinations of incarnations of audio sharing devices and personal electronic devices are employed, and at least some of the resulting capabilities. The network 2100 incorporates a personal electronic device 900 capable of two-way audio communication, along with an audio sharing device 200 capable of two-way audio communication and retransmission, and an audio sharing device 100 capable of only outputting audio that it receives to its user and retransmitting that audio to yet another device (not shown). The network 2200 incorporates a personal electronic device 900 capable of only transmitting audio communication, along with two audio sharing devices 200a and 200b that are each capable of two-way audio communication and retransmission. Not unlike the networks 1100 and 1200 of FIGS. 1 and 3, the personal electronic devices 900 in both networks 2100 and 2200 of FIGS. 5 and 6, respectively, have a point-to-point link with one of the depicted audio sharing devices, and that each of those depicted audio sharing devices have a separate point-to-point link with the other of the depicted audio sharing devices, resulting in a chain of point-to-point links.

With the audio sharing device 100 of the network 2100 of FIG. 5 limited to being able to only receive audio from its point-to-point, link with the audio sharing device 200, the audio sharing device 100 may enable its user to hear a two-way exchange of audio between the audio, sharing device 200 and the personal electronic device 900, but cannot enable its user to participate in that two-way exchange by speaking. Alternatively, rather than listening to a two-way exchange of audio between audio sharing device 200 and the personal electronic device 900, the user of the audio sharing device 100 may listen to unrelated audio transmitted by the personal electronic device 900 and retransmitted by the audio sharing device 900. This unrelated audio could, for example, be an audio recording stored on the personal device 900 that the user of the audio sharing device 200 is willing to allow the user of the audio sharing device 100 to hear through retransmission by the audio sharing device 200. Despite being only able to receive audio from the personal electronic device 900, in some embodiments, the user of the audio sharing device 100 may still be able to operate a control of the audio sharing device 100 to remotely operate at least some aspect of the personal electronic device 900, perhaps controlling some aspect of the provision of the audio.

With the personal electronic device 900 of the network 2200 of FIG. 6 limited to being able to only transmit audio across its point-to-point link with the audio sharing device 200a, the audio sharing devices 200a and 200b may enable their users to hear the audio from the personal electronic device 900 and/or to talk to each other, but neither user can transmit audio back to the personal electronic device 900. Despite being only able to receive audio from the personal electronic device 900, in some embodiments, the users of either of the audio sharing devices 200a and 200b may still be able to operate a control of their respective ones of the audio sharing devices 200a and 200b. to remotely operate at least some aspect of the personal electronic device 900, perhaps controlling some aspect of the provision of the audio.

Other embodiments are within the scope of the following claims.

What is claimed is:

1. An apparatus comprising:
a processor;
a transceiver accessible to the processor and configured to send and receive wireless communications in a wireless network; and
a storage accessible to the processor and having a routine stored, therein comprising a sequence of instructions that when, executed by the processor causes the processor to:
operate the transceiver to receive a first piece of audio from a first external electronic device;
operate the transceiver to retransmit at least a portion of the first piece of audio to a second external electronic device; and
provide at least a portion of the first piece of audio to a digital-to-analog converter to create an analog audio signal to drive an acoustic driver.

2. The apparatus of claim 1, wherein the transceiver is configured to send and receive the first piece of audio in the wireless network in conformance with the Bluetooth specification.

3. The apparatus of claim 1, wherein the transceiver is configured to receive audio comprising multiple audio channels, wherein the first piece of audio comprises a first audio channel and a second audio channel, and wherein the processor is further caused by the routine to provide the first audio channel of the first piece of audio to the digital-to-analog converter and to operate the transceiver to retransmit the second audio channel of the first piece of audio to the second external electronic device.

4. The apparatus of claim 3, wherein the processor is farther caused by the routine to create a synchronization signal and to operate the transceiver to transmit the synchronization signal to the second external electronic device to enable synchronization of output of the first audio channel by the acoustic driver with output of the second audio channel by another acoustic driver that is driven by the second electronic device.

5. The apparatus of claim 3, wherein the processor is further caused by the routine to store at least a portion of the first piece of audio, and to delay the provision of the first audio channel of the first piece of audio to the digital-to-analog converter to enable synchronizing the driving of the acoustic driver with the driving of another acoustic driver that is driven by the second external electronic device.

6. The apparatus of claim 1, wherein the acoustic driver is external to a casing of the apparatus, and wherein the apparatus further comprises a connector to enable the connection of the apparatus to the acoustic driver.

7. The apparatus of claim 6, wherein the digital-to-analog converter is disposed within the easing of the apparatus, and wherein the connector is able to convey an analog signal representative of at least a portion of the first piece of audio to the acoustic driver.

8. The apparatus of claim 6, wherein the digital-to-analog converter is external to the casing of the apparatus, and the wherein the connector is able to convey a digital signal representative of at least a portion of the first piece of audio to the digital-to-analog converter.

9. The apparatus of claim 1, further comprising:
the digital-to-analog converter; and
the acoustic driver.

10. The apparatus of claim 1, wherein the processor is further caused by the routine to:
receive a second piece of audio from a microphone through an analog-to-digital converter; and
operate the transceiver to transmit the second piece of audio to at least one of the first external electronic device and the second external electronic device.

11. The apparatus of claim 10, wherein the microphone is external to a casing of the apparatus, and wherein the apparatus further comprises a connector to enable the connection of the apparatus to the microphone.

12. The apparatus of claim 11, wherein the analog-to-digital converter is disposed within the casing of the apparatus, and wherein the connector is able to convey an analog signal representative of the second piece of audio to be received by the analog-to-digital converter from the microphone.

13. The apparatus of claim 11, wherein the analog-to-digital converter is external to the casing of the apparatus, and wherein the connector is able to convey a digital signal representative of the second piece of audio to be received by the processor from the analog-to-digital converter.

14. The apparatus of claim 10, further comprising:
the analog-to-digital converter; and
the microphone.

15. The apparatus of claim 1, further comprising a control that is manually operable by a user of the apparatus, and wherein the processor is further caused by the routine to;
monitor the control for an indication of being manually operated; and
upon receiving an indication of the control being manually operated, operate the transceiver to transmit a command to the first external electronic device that is related to the first external electronic device transmitting the first piece of audio to the apparatus.

16. The apparatus of claim 1, further comprising an indicator configured to provide a piece of information to a user of the apparatus, and wherein the processor is further caused by the routine to:
operate the transceiver to receive the piece of information from the first external electronic device; and
upon receiving the piece of information, operate the indicator to provide that piece of information to the user.

17. The apparatus of claim 1, wherein the processor is further caused by the routine to:
operate the transceiver to receive a piece of information from the first external electronic device;
upon receiving the piece of information, create an audio signal conveying the piece of information; and
mix the audio signal conveying the piece of information with the portion of the first piece of audio provided to the digital-to-analog converter.

18. The apparatus of claim 1, further comprising a control that is manually operable by a user of the apparatus to initiate a link establishment procedure to set up a link with at least one of the first external electronic device and the second external electronic device.

19. The apparatus of claim 18, wherein the control is manually operable to initiate the link establishment procedure as a simplified form of link establishment procedure with one of the first external electronic device and the second external electronic device, but not the other.

20. The apparatus of claim 18, wherein the processor is further caused by the routine to:
monitor the control for an indication of being manually operated; and
operate the transceiver to initiate the link establishment procedure with the one of the first external electronic device and the second external electronic device.

21. The apparatus of claim 20, wherein the processor is further caused by the routine to:
operate the transceiver to receive an indication that the one of the first external electronic device and the second external electronic device is an audio sharing device; and
alter the link establishment procedure to a simplified form of link establishment procedure.

22. The apparatus of claim 20, wherein the processor is further caused by the routine to, upon completion of the link establishment procedure, operate the indicator to provide an indication to the user that the link establishment procedure is completed.

23. A machine-readable medium storing a sequence of instructions that when executed by a processor of an audio sharing device cause the processor to:
operate a transceiver configured to send and receive wireless communications in a wireless network to receive a first piece of audio from a first external electronic device;
operate the transceiver to retransmit at least a portion of the first piece of audio to a second external electronic device; and
provide, at least a portion of the first piece of audio to a digital-to-analog converter to create an analog audio signal to drive an acoustic driver.

24. The machine-readable medium of claim 23, wherein the first piece of audio comprises a first audio channel and a second audio channel, and wherein the sequence of instructions further causes the processor to:
provide the first audio channel of the first piece of audio to the digital-to-analog converter; and
operate the transceiver to retransmit the second audio channel of the first piece of audio to the second external electronic device.

25. The machine-readable medium of claim 24, wherein the sequence of instructions further causes the processor to:
store as least a portion of the first piece of audio, and
delay the provision of the first audio channel of the first piece audio to the digital-to-analog converter to enable synchronizing the driving of the acoustic driver with the driving of another acoustic driver that is driven by the second external electronic device.

26. The machine-readable medium of claim 24, wherein the sequence of instructions further causes the processor to:
create a synchronization signal; and
operate the transceiver to transmit the synchronization signal to the second external electronic device to enable synchronization of output of the first audio channel by the acoustic driver with output of the second audio channel by another acoustic driver that is driven by the second external electronic device.

27. The machine-readable medium of claim 23, wherein the sequence of instructions further causes the processor to:
receive a second piece of audio from a microphone through an analog-to-digital converter; and
operate the transceiver to transmit the second piece of audio to at least one of the first external electronic device and the second external electronic device.

28. The machine-readable medium of claim 23, wherein the sequence of instructions further causes the processor to:
monitor a control that is manually operable for an indication of being manually operated; and
upon receiving an indication of the control being manually operated, operate the transceiver to transmit a command to the first external electronic device that is related to the first external electronic device transmitting the first piece of audio to the apparatus.

29. The machine-readable medium of claim 23, wherein the sequence of instructions further causes the processor to:
operate the transceiver to receive a piece of information related to the first piece of audio from the first external electronic device; and
upon receiving the piece of information, operate the indicator to provide the piece of information to a person.

30. The machine-readable medium of claim 23, wherein the sequence of instructions further causes the processor to:
operate the transceiver to receive a piece of information related to the first piece of audio from the first external electronic device;
upon receiving the piece of information, create an audio signal conveying the piece of information; and
mix the audio signal conveying the piece of information with the portion of the first piece of audio provided to the digital-to-analog converter.

31. The machine-readable medium of claim 23, wherein the sequence of instructions further causes the processor to:
monitor a control that is manually operable for an indication of being manually operated; and
operate the transceiver to initiate a link establishment procedure with the one of the first external electronic device and the second external electronic device.

32. The machine-readable medium of claim 31, wherein the sequence of instructions further causes the processor to:
operate the transceiver to receive an indication that the one of the first external electronic device and the second external electronic device is an audio sharing device; and
alter the link establishment procedure to a simplified form of link establishment procedure.

33. The machine-readable medium of claim 31, wherein the sequence of instructions further cause the processor to, upon completion of the link establishment procedure, operate an indicator to provide an indication to a person that the link establishment procedure is completed.

34. A portable audio sharing device comprising:
a processor;
a transceiver accessible to the processor and configured to send and receive wireless communications in a wireless network;
a digital-to-analog converter;
an acoustic driver to provide audio to an ear of the person; and
a storage accessible to the processor and having a routine stored therein comprising a sequence of instructions that when executed by the processor causes the processor to:
operate the transceiver to receive a first piece of audio from a first external electronic device;
operate the transceiver to retransmit at least a portion of the first piece of audio to a second external electronic device: and
provide at least a portion of the first piece of audio to the digital-to-analog converter to create an analog audio signal to drive the acoustic driver.

35. The portable audio sharing device of claim 34, wherein the transceiver is configured to send and receive the first piece of audio in the wireless network in conformance with the Bluetooth specification.

36. The portable audio sharing device of claim 34, further comprising another acoustic driver to provide audio to another ear of the person, wherein the transceiver is configured to receive audio comprising multiple audio channels, wherein the first piece of audio comprises a first audio channel and a second audio channel, wherein the digital-to-analog converter creates another analog signal to drive the another acoustic driver, and wherein the audio signal for the acoustic driver is representative of the first audio channel and the another audio signal for the another driver is representative of the second audio channel.

37. The portable audio sharing device of claim 34, further comprising a microphone and an analog-to-digital converter, and wherein the processor is further caused by the routine to:
receive a second piece of audio from a microphone through the analog-to-digital converter; and
operate the transceiver to transmit the second piece of audio to at least one of the first external electronic device and the second external electronic device.

38. The portable audio sharing device of claim 34, further comprising a control that is manually operable by the person, and wherein the processor is further caused by the routine, to:
monitor the control for an indication of being manually operated; and
upon receiving an indication of the control being manually operated, operate the transceiver to transmit a command to the first external electronic device that is related to the first external electronic device transmitting the first piece of audio to the audio sharing device.

39. The portable audio sharing device of claim 34, wherein the processor is further caused by the routine to:
operate the transceiver to receive a piece of information from the first external electronic device;
upon receiving the piece of information, create an audio signal conveying the piece of information; and
mix the audio signal conveying the piece of information with the portion of the first piece of audio provided to the digital-to-analog converter.

40. The portable audio sharing device of claim 34, further comprising a control that is manually operable by the person, and wherein the processor is further caused by the routine to:
monitor the control for an indication of being manually operated;
operate the transceiver to initiate the link establishment procedure with the one of the first external electronic device and the second external electronic device;
operate the transceiver to receive an indication that the one of the first external electronic device and the second external electronic device is also an audio sharing device; and
alter the link establishment procedure to a simplified form of link establishment procedure.
